(19) United States
(12) Patent Application Publication
(10) Pub. No.: US 2010/0036847 A1
(43) Pub. Date: Feb. 11, 2010

(54) EXTENDABLE AND PLUGGABLE METHOD FOR VALIDATING XML DATA

(75) Inventors: Valentina Birsan, Toronto (CA); Sheldon Lee-Loy, Markham (CA); Ali Mehregani, Richmond Hill (CA); David L. Whiteman, Apex, NC (US)

Correspondence Address: Oppenheimer Wolff & Donnelly LLP, Plaza VII, Suite 3300, 45 South Seventh Street, Minneapolis, MN, 55402-1609, US

(73) Assignee: International Business Machines Corporation, Armonk, NY (US)

(21) Appl. No.: 12/188,865

(22) Filed: Aug. 8, 2008

(51) Int. Cl. G06F 17/30

(52) U.S. Cl. 707/9; 707/E17.005

(57) ABSTRACT

A method of validating XML data comprises (a) registering a plurality of validators that are each responsible for validating a certain XML set of rules, (b) creating common XML data structures to be shared between the validators, (c) invoking registered validators and granting access to common XML data structures, and (d) reporting validation results for each of the validators. Two or more validators having similar pattern validation structures may share the common XML data structure of a data builder. Furthermore, the validators may be invoked in the order in which they are registered in step (a) and granted access to the common XML data structures that are built in step (b). In addition, the step of reporting the validation results may include formatting the validation results as error messages generated by each validator and outputting the error messages via an outputter.

### FIELD OF THE INVENTION

The present invention generally relates to the field of processing XML data in computer applications. In particular, the present invention is directed to an XML validation system for and method of validating XML data.

### BACKGROUND OF THE INVENTION

Extensible markup language (XML) is a general-purpose specification for creating custom markup languages. It is classified as an extensible language because it allows its users to define their own elements. The primary purpose of XML is to facilitate the sharing of structured data across different information systems, particularly via the Internet.

When an XML message is exchanged between different applications, often times the XML message must be validated against the XML language that is used by the receiving application. XML validators are applications that are used to validate XML messages against a certain schema. To be able to validate an XML message, the validator may implement a set of core rules (i.e., XML rules that are common for every XML language) as well as a set of specific rules (i.e., XML rules that are characteristic to some XML language profiles).

There may be a great deal of redundancy when building validation tools because all validators provide their own implementation of the common set of rules. In order to avoid this redundancy in implementation, it is preferable that producers of XML schema validators be able to reuse implementations of common functions that are implemented by other validators. Also, it may be beneficial that new validators be able to extend existing validators by providing implementation to new rules that are not covered by the extended validator. However, existing validation tools do not allow a validator to reuse or extend implementation rules from other validators. Additionally, if more than one validator exists for a set of rules, it may be beneficial that a user be able to choose the validator he/she wishes to use for validating these rules. Again, existing validation tools do not provide this capability.

Therefore, a need exists for new approaches to validating XML data in order to allow validators to reuse or extend implementation rules from other validators and to allow the user to plug in a selected version of a validator for validating any set of rules.

### BRIEF SUMMARY OF THE INVENTION

The present invention solves the foregoing problems by providing a method for validating XML data that comprises (a) registering a plurality of validators that are each responsible for validating a certain XML set of rules, (b) creating common XML data structures to be shared between the validators, (c) invoking registered validators and granting access to common XML data structures, and (d) reporting validation results for each of the validators. Two or more validators having similar pattern validation structures may share the common XML data structure of a data builder. Furthermore, the validators may be invoked in the order in which they are registered in step (a) and granted access to the common XML data structures that are built in step (b). In addition, the step of reporting the validation results may include formatting the validation results as error messages generated by each validator and outputting the error messages via an outputter.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a functional block diagram of an XML validation system for performing an extendable and pluggable method of validating XML data; and

FIG. 2 illustrates a flow diagram of a method of validating XML data, which is an extendable and pluggable method of validating XML data.

### DETAILED DESCRIPTION OF THE INVENTION

The present invention is an XML validation system for and method of validating XML data. In particular, the XML validation system and method of the invention provide an extendable and pluggable framework for building XML data validators. By using this framework, a new validator can plug into an existing validator and extend the existing validator with implementation of new rules. This framework also allows users to plug in a desired version of a validator for any set of rules, assuming different validators exist for such rules.

One aspect of the XML validation system and method of the present invention is that it may provide an extensible framework for validating different types of schema profiles. Another aspect of the XML validation system and method of the present invention is that it may provide a validation framework that may be easily configured to add or remove validator rules. Yet another aspect of the XML validation system and method of the present invention is that in cases in which certain validation rules check similar sets of conditions, the XML validation system may be able to recognize this fact and allow the pluggable validation components to share validation structures. This capability may reduce the runtime memory and processing time during validation. Still another aspect of the XML validation system and method of the present invention is that it may provide a common error reporting mechanism that allows each pluggable validation component to contribute error messages to a common error output log.

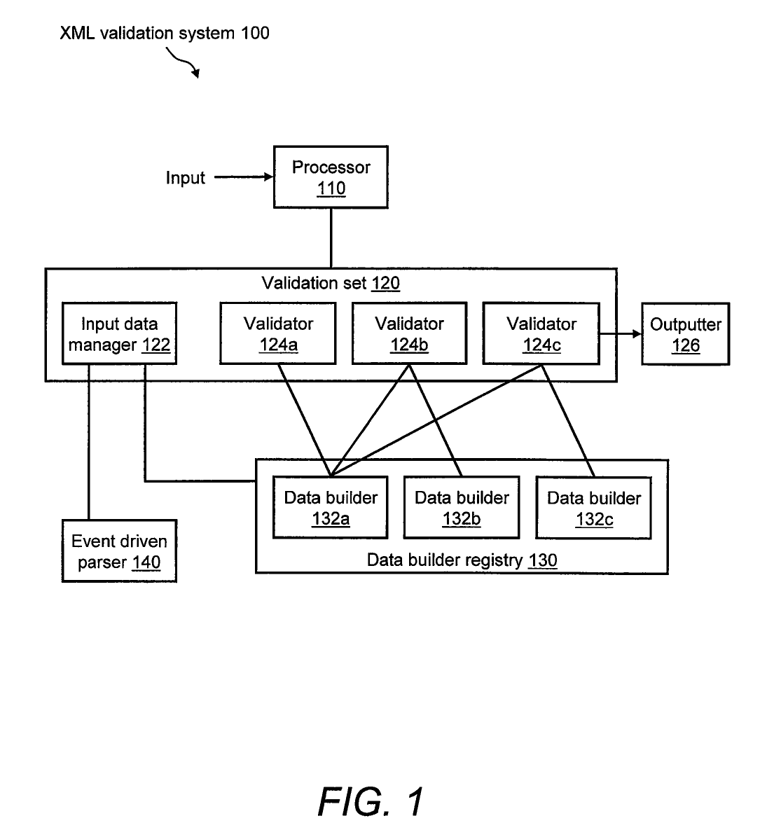

FIG. 1 illustrates a functional block diagram of one exemplary embodiment of an XML validation system 100 for performing an extendable and pluggable method of validating XML data. XML validation system 100 may include a processor 110, a validation set 120, and a data builder registry 130. Validation set 120 of XML validation system 100 further includes an input data manager 122 and multiple validators 124 such as, but not limited to, validators 124a, 124b, and 124c. Additionally, validators 124 may feed an outputter 126. Data builder registry 130 of XML validation system 100 may further include multiple data builders 132 such as, but not limited to, data builders 132a, 132b, and 132c. Additionally, XML validation system 100 may include an event driven parser 140.

Processor 110, which is the main processor of XML validation system 100, may be the entry point of the XML input data as illustrated in FIG. 1. Processor 110 may be used to manage the overall operations of XML validation system 100 and, in particular, to manage the life cycle of the set of validators 124 and data builders 132.

Input data manager 122 of validation set 120 may provide a mechanism to read data from an XML document. Input data manager 122 may be event-driven in nature and provide a set of callback methods that may be invoked when events occur during parsing. The parsing of the XML documents may be performed by events driven parser 140. Events driven parser 140 may be, for example, a SAX parser (i.e., Simple API for XML parser).

Data builders 132 of data builder registry 130 may be designed to integrate with input data manager 122 and used for creating data structures that any validator 124 of validation set 120 may use to check its validity.

Each validator 124 may then process a set of data structures and determine whether the data structures conform to an expected configuration. Each validator 124 may be registered in order to validate a set of rules. Validators 124 that are associated with processor 110 may be registered or deregistered.

Outputter 126 may be a component that is registerable with processor 110 and that provides a mechanism to log error reports. Processor 110 may be configured such that it makes outputter 126 available to each validator 124 so that each validator 124 may log error messages to a common output format.

The operation of the exemplary XML validation system 100 may be summarized as follows. Processor 110 is responsible for managing validation set 120, which includes components that are defined as validators. A special type of validator may be defined in the first position of validation set 120. For example, in XML validation system 100, input data manager 122 is the special type of validator that is defined in the first position of validation set 120. The purpose of input data manager 122 is to provide a parsing mechanism for the entire XML validation system 100. What follows in validation set 120 is a collection of validators 124. Each validator 124 may be responsible for validating a particular XML set of rules. During the start up routine of processor 110, validators 124 may be added to and/or removed from validation set 120. Furthermore, the order of the validation may also be configured. Certain validators 124 may be assigned a priority based on various metrics, including but not limited to validation time. For example, validators 124 that have short validation times may be assigned a higher priority than validators 124 that have long validation times.

Once validation set 120 is configured, processor 110 may then process each validator 124 in order. Each validator 124 may be designed to undergo two phases of processing—(1) an initialization phase and (2) a validation phase.

Initialization Phase of the Validation Set

In the initialization phase, input data manager 122 may first be initialized because it is in the first position of validation set 120. Input data manager 122 may be a type of validator that serves as an event handler that defines a set of callback methods that processes SAX events. During the initialization phase, input data manager 122 may instantiate event driven parser 140, which is the SAX parser, and bind to it. Processor 110 may then initialize subsequent validators 124. These validators 124 may be responsible for implementing the semantic checks for XML schema features. During the initialization phase, each validator 124 may register a set of data builders 132 to data builder registry 130. It is contemplated that a certain validator 124 may require zero or more data structures. As such, zero or more data builders 132 may be associated with a certain validator 124. By contrast, a certain data builder 132 may be associated with one or more validators 124.

One benefit of the relationship between validators 124 and data builders 132 that is shown in FIG. 1 is realized when two or more validators 124 have similar pattern validation structures. In these cases a common data structure may be created and shared between the validators 124. This may reduce the data structure formation time in the validation process. This architecture may also provide a mechanism to reuse existing data builders 132 in order to construct new validators 124, and thereby reduce the development time.

Once all validators 124 are initialized, input data manager 122 may start parsing the XML input document. It is important to note that input data manager 122 may act as a gate keeper of the XML input data. Each data builder 132 may provide filtering criterion that filters the input that is received by input data manager 122. This may reduce the amount of input data that each data builder 132 processes, which may in turn increase the validation capability. As the SAX events are received from event driven parser 140, input data manager 122 may read the filter criterion for each data builder 132 and determine whether the SAX event should be sent to certain data builders 132.

Validation Phase of the Validation Set

After all data builders 132 have constructed their data structures, processor 110 may then start the validation phase of the set of validators 124. At the start of the validation phase each validator 124 may receive the data structures from the data builders 132 that it registered. Each validator 124 may determine whether each data structure conforms to an expected configuration. If the data structure is found to conform, the validation phase may then terminate. However, if the data structure is found not to conform, an error may be generated. The error may then be reported to outputter 126, which may registered with processor 110 as previously discussed.

Processor 110 finishes validating the input document when all validators 124 complete their validation phases. At the end of this process, outputter 126 may contain any error messages that have been generated by each validator 124.

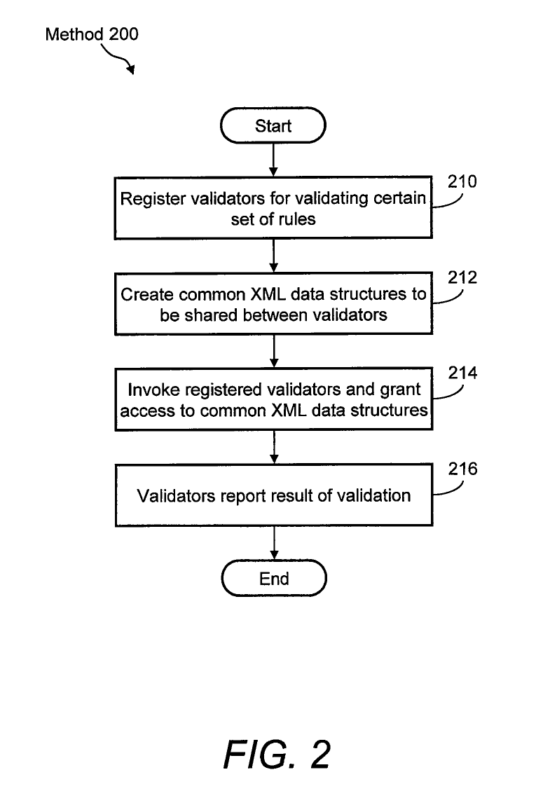

FIG. 2 is a flow diagram illustrating one exemplary method 200 of validating XML data, which is an extendable and pluggable method of validating XML data, by use of XML validation system 100 previously described. Method 200 may include, but is not limited to, the steps described below.

As illustrated in FIG. 2, method 200 begins with an initialization step 210, where the validators 124 associated with processor 110 may be registered (or deregistered). For example, during the start up routine of processor 110, validators 124 may be added to and/or removed from validation set 120. Each validator 124 that is registered may be responsible for validating a certain XML set of rules.

The method 200 continues at step 212, which is a data building step, wherein common XML data structures are created to be shared between validators 124. The relationship between validators 124 and data builders 132 allows two or more validators 124 that have similar pattern validation structures to share common XML data structures. In one embodiment (with reference to FIG. 1), validator 124a and validator 124b may have similar pattern validation structures and, therefore, may share the common XML data structure of data builder 132a. Likewise, validator 124a and validator 124c may have similar pattern validation structures and, therefore, may share the common XML data structure of data builder 132a.

Next, at validation step 214, registered validators 124 may be invoked by XML validation system 100 and granted access to common data structures. For example, validators 124 may be invoked in the order in which they are initialized in step 210 and granted access to the common XML data structures that are built in step 212.

The method 200 ends with a reporting step 216, wherein validators 124 report the result of their validation operations. For example, each validator 124 may return the result of its validation. As one skilled in the art will appreciate, all results may be collected by XML validation system 100. Based on the output settings of XML validation system 100, the composed result may be formatted and presented to the user via outputter 126. For example, outputter 126 may contain error messages that have been generated by each validator 124.

Although the present invention has been described with reference to preferred embodiments, workers skilled in the art will recognize that changes may be made in form and detail without departing from the spirit and scope of the invention.

1. A method of validating XML data comprising:
(a) registering a plurality of validators, wherein each validator that is registered is responsible for validating a certain XML set of rules;
(b) creating common XML data structures to be shared between the validators, wherein two or more of the validators having validation rules that evaluate the same set of conditions plug-into and share the common XML data structure of a data builder to eliminate redundancy in the creation of XML data structures and extend a selected XML data structure to multiple validators;
(c) invoking registered validators and granting access to common XML data structures, wherein the validators are invoked in the order in which they are registered in step (a) and granted access to the common XML data structures that are built in step (b); and
(d) reporting validation results for each of the validators previously registered, wherein the step of reporting the validation results includes formatting the validation results as error messages generated by each validator and outputting the error messages via an outputter.
